(19) United States
(12) Patent Application Publication
(10) Pub. No.: US 2026/0138484 A1
(43) Pub. Date: May 21, 2026

(54) CHARGING CONTROL DEVICE AND CHARGING SYSTEM FOR VEHICLE

(71) Applicant: TOYOTA JIDOSHA KABUSHIKI KAISHA, Toyota-shi (JP)

(72) Inventor: Tatsuya Fujii, Nagakute-shi (JP)

(73) Assignee: TOYOTA JIDOSHA KABUSHIKI KAISHA, Toyota-shi (JP)

(21) Appl. No.: 19/364,545

(22) Filed: Oct. 21, 2025

(30) Foreign Application Priority Data
Nov. 20, 2024 (JP) 2024-202232

(51) Int. Cl. B60L 53/62; B60L 7/10; B60L 58/12

(52) U.S. Cl. CPC B60L 53/62; B60L 7/10; B60L 58/12; B60L 2240/545

(57) ABSTRACT

A charging/discharging device is configured to perform V2X charging/discharging with a charging/discharging station. A server formulates a V2X charging/discharging plan for charging/discharging a battery by the charging/discharging device such that an SOC of the battery does not exceed a set SOC upper limit value, and predicts a temperature of the battery after completion of the V2X charging/discharging based on the V2X charging/discharging plan. When the predicted temperature of the battery after completion of the V2X charging/discharging is low, the server formulates (updates) the V2X charging/discharging plan by setting the SOC upper limit value lower than that when the predicted temperature is high.

### CROSS-REFERENCE TO RELATED APPLICATIONS

This nonprovisional application is based on Japanese Patent Application No. 2024-202232 filed on November 20, 2024 with the Japan Patent Office, the entire contents of which are hereby incorporated by reference.

### BACKGROUND

### Field

The present disclosure relates to a charging control device for a vehicle and a charging system including the same.

### Description of the Background Art

Japanese Patent Laying-Open No. 2020-68568 describes an electrically powered vehicle in which a vehicle-mounted secondary battery is charged from a system power supply (external charging), and the vehicle is driven by a motor generator using electric power stored in the battery. During braking of the vehicle, the motor generator performs a regeneration operation, and regenerative electric power generated by the regeneration operation is stored in the battery. In this vehicle, the lower the temperature of the battery and the higher the SOC (State Of Charge) of the battery, the smaller the charging current of the battery.

In the above publication, when the temperature of the battery is low and the SOC is high during traveling after external charging (for example, after the start of traveling), the charging current of the battery is reduced, and thus the regenerative electric power is limited during braking of the vehicle. Therefore, there is a possibility that the regenerative energy cannot be effectively utilized.

### SUMMARY

The present disclosure is made to solve such a problem, and an object of the present disclosure is to provide a charging control device and a charging system for a vehicle that can effectively utilize regenerative energy for traveling of the vehicle after external charging.

A charging control device according to the present disclosure is a charging control device for a vehicle, and the vehicle includes a battery that stores electric power for traveling, a driving device, and a charging device. The driving device generates a driving force for the vehicle using electric power stored in the battery, and generates regenerative electric power during braking of the vehicle to charge the battery. The charging device charges the battery with a power supply external to the vehicle (external charging). The charging control device includes a processor and a memory that stores a program to be executed by the processor. In accordance with the program, the processor makes a charging plan for charging the battery by the charging device such that an SOC of the battery does not exceed a set SOC upper limit value, and predicts a temperature of the battery after being externally charged based on the charging plan. When the predicted temperature of the battery after being externally charged is low, the processor makes the charging plan by setting the SOC upper limit value lower than the SOC upper limit value when the predicted temperature is high.

In this charging control device, the charging plan is made such that the SOC of the battery does not exceed a set SOC upper limit value. When the predicted temperature of the battery after being charged based on the charging plan is low, the charging plan is made by setting the SOC upper limit value lower than that when the predicted temperature is high. Accordingly, after the external charging, the SOC is set low when the temperature of the battery is low, and therefore, limitation on the regenerative electric power during braking of the vehicle is relaxed. Thus, it is possible to effectively utilize the regenerative energy for traveling after external charging.

When charging power for the battery is limited to a predetermined value or less due to a decrease in the temperature of the battery, the processor may make the charging plan by setting the SOC upper limit value to a lower value.

When the charging power for the battery is limited to the predetermined value or less due to a decrease in the temperature of the battery, the processor may make the charging plan by lowering the SOC upper limit value set by a user of the vehicle.

The processor may make the charging plan such that charging of the battery has been completed at a set travel start time of the vehicle, and predict the temperature, at the travel start time, of the battery after being charged based on the charging plan.

A charging system according to the present disclosure is a charging system used for charging a vehicle, and includes a charging facility to which the vehicle is to be connected, and a charging control device for the vehicle. The vehicle includes a battery that stores electric power for traveling, a driving device, and a charging device. The driving device generates a driving force for the vehicle using electric power stored in the battery, and generates regenerative electric power during braking of the vehicle to charge the battery. The charging device charges the battery with electric power supplied from the charging facility (external charging). The charging control device makes a charging plan for charging the battery by the charging facility such that an SOC of the battery does not exceed a set SOC upper limit value, and predicts a temperature of the battery after being charged based on the charging plan. When the predicted temperature of the battery is low, the charging control device makes the charging plan by setting the SOC upper limit value lower than the SOC upper limit value when the predicted temperature is high. The charging facility charges the battery in accordance with the charging plan made by the charging control device.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an overall configuration of an energy management system according to an embodiment of the present disclosure.

FIG. 2 is a diagram showing charging characteristics of a battery.

FIG. 3 is a timing chart when the SOC upper limit value is changed.

FIG. 4 is a flowchart illustrating a process performed by a server regarding V2X charging/discharging.

FIG. 5 is a flowchart illustrating a process executed by a server according to a first modification.

FIG. 6 is a flowchart illustrating a process executed by a server according to a second modification.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

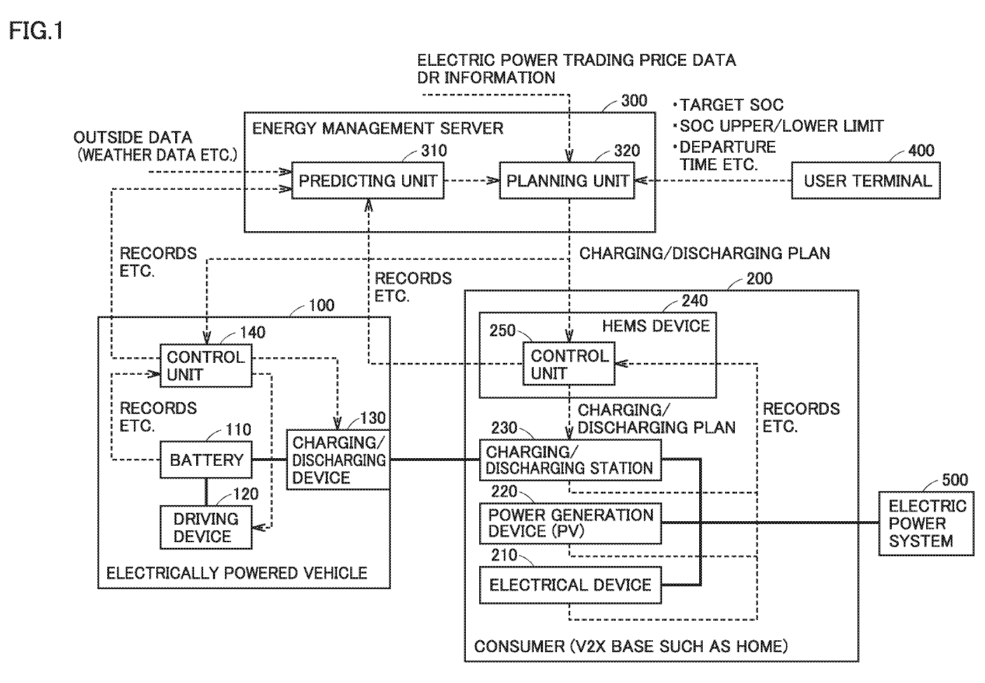

FIG. 1 is a diagram illustrating an overall configuration of an energy management system according to an embodiment of the present disclosure. Referring to FIG. 1, the energy management system (hereinafter, this will be referred to as "EMS (Energy Management System)") includes an electrically powered vehicle 100, a consumer facility 200, an energy management server (hereinafter, it is simply referred to as a "server") 300, and a user terminal 400.

In the EMS, electric power can be exchanged between the electrically powered vehicle 100 and the consumer facility 200. Hereinafter, the exchange of electric power between the electrically powered vehicle 100 and the consumer facility 200 is referred to as "V2X charging/discharging".

The V2X charging/discharging is planned by the server 300 based on the supply/demand situation of the electric power system 500, the implementation request of the DR in the case of participating in the demand response (DR), the power trade price, the power supply/demand situation of the consumer facility 200, the usage situation of the electrically powered vehicle 100, the charging/discharging capability of the electrically powered vehicle 100, the amount of electric power stored in the electrically powered vehicle 100, various settings by the user, and the like.

The electrically powered vehicle 100 is a vehicle that can travel using electric power stored in a battery, and is, for example, an electric vehicle (BEV: Battery Electric Vehicle), a plug-in hybrid vehicle (PHEV: Plug-in Hybrid Electric Vehicle), or the like. Hereinafter, the electrically powered vehicle 100 is referred to as a BEV.

Electrically powered vehicle 100 includes a battery 110, a driving device 120, a charging/discharging device 130, and a control unit 140. The battery 110 is a power storage element configured to be chargeable and dischargeable, and includes, for example, a secondary battery such as a lithium ion battery or a nickel-metal hydride battery. The battery 110 stores electric power for generating the travel driving force by the driving device 120, and supplies the stored electric power to the driving device 120. In addition, the battery 110 can store regenerative electric power generated by the driving device 120 during braking of the vehicle.

Further, the battery 110 is electrically connected to a charging/discharging station 230 (described later) provided in the consumer facility 200 through the charging/discharging device 130, and can exchange electric power with the charging/discharging station 230 (the consumer facility 200) (V2X charging/discharging).

The driving device 120 generates a traveling driving force of the electrically powered vehicle 100. The driving device 120 is configured to include a motor generator that generates a traveling driving force and an inverter that drives the motor generator (both are not shown). The inverter is provided between the battery 110 and the motor generator. A converter may be provided between the inverter and the battery 110. During braking of the electrically powered vehicle 100, the motor generator generates electric power by the rotational force of the drive wheels, and the generated electric power (regenerative electric power) can be stored in the battery 110.

Charging/discharging device 130 is a device for electrically powered vehicle 100 to perform V2X charging/discharging. The charging/discharging device 130 includes an inlet to which a connector provided on a power cable of the charging/discharging station 230 can be connected, a relay that is closed during V2X charging/discharging, and a charging/discharging device (neither of which are shown). When the battery 110 is charged from the charging/discharging station 230, the charger/discharger converts electric power supplied from the charging/discharging station 230 into electric power capable of charging the battery 110. On the other hand, when power is supplied from the battery 110 to the charging/discharging station 230, the charging/discharging device converts power discharged from the battery 110 into power that can be supplied to the consumer facility 200. The charger/discharger is constituted by, for example, an AC/DC converter. Note that the charging/discharging device may be provided on the charging/discharging station 230 side.

The control unit 140 is configured to include a processor such as a CPU (Central Processing Unit), a memory (ROM (Read Only Memory) and RAM (Random Access Memory)), and a signal buffer for inputting and outputting various signals (all not shown). The control unit 140 controls the driving device 120 to execute various processes for realizing traveling of the electrically powered vehicle 100. The control unit 140 calculates the SOC of the battery 110. The SOC can be calculated by various known methods.

Further, the control unit 140 receives a V2X charging/discharging plan formulated by the server 300 from the server 300. Then, when the connector of the charging/discharging station 230 is connected to the charging/discharging device 130, the control unit 140 controls the charging/discharging device 130 according to the V2X charging/discharging plan to perform V2X charging/discharging with the charging/discharging station 230 of the consumer facility 200.

The consumer facility 200 is electrically connected to the electric power system 500 and can exchange electric power with the electric power system 500. The consumer facility 200 is, for example, a home or the like of an owner of the electrically powered vehicle 100. The consumer facility 200 includes an electrical device 210, a power generation device 220, a charging/discharging station 230, and a HEMS (Home Energy Management System) device 240.

The electrical devices 210 are various electrical loads in the consumer facility 200. The power generation device 220 is a facility capable of generating power in the consumer facility 200, and is, for example, a PV (Photovoltaic) device. The charging/discharging station 230 is a facility for the electrically powered vehicle 100 to perform V2X charging/discharging with the consumer facility 200, and is electrically connected to the electrically powered vehicle 100 through the charging/discharging device 130 of the electrically powered vehicle 100.

The charging/discharging station 230 is electrically connected to the electric power system 500, the electrical device 210, and the power generation device 220. When electrically powered vehicle 100 is connected, charging/discharging station 230 can supply electric power from electric power system 500 or power generation device 220 to electrically powered vehicle 100 to charge battery 110 of electrically powered vehicle 100 (V2X charging). On the other hand, the charging/discharging station 230 can supply electric power supplied (discharged) from the electrically powered vehicle 100 to the electrical device 210 or the electric power system 500 (V2X discharging).

The HEMS device 240 is a device for managing various electric facilities and power of the consumer facility 200. The HEMS device 240 manages operations of the electrical device 210, the power generation device 220, and the charging/discharging station 230, and power in the consumer facility 200. The HEMS device 240 includes a control unit 250.

The control unit 250 includes a processor such as a CPU, a memory (a ROM and a RAM), and a signal buffer for inputting and outputting various signals (both are not shown). The control unit 250 manages the electric power in the consumer facility 200 by controlling the electrical device 210 and the power generation device 220.

Further, the control unit 250 receives the V2X charging/discharging plan formulated by the server 300 from the server 300. Then, when the electrically powered vehicle 100 is connected to the charging/discharging station 230, the control unit 250 controls the charging/discharging station 230 according to the V2X charging/discharging plan, and performs V2X charging/discharging between the electrically powered vehicle 100 and the charging/discharging station 230 in cooperation with the electrically powered vehicle 100.

The server (charging control device) 300 executes various processes for formulating a plan of V2X charging/discharging by the electrically powered vehicle 100. The server 300 includes a processor such as a CPU, a memory (a ROM and a RAM), and a signal buffer for inputting and outputting various signals (both are not shown). The processor loads a program stored in the ROM into the RAM and executes the program. Various processes executed by the server 300 are described in the program stored in the ROM.

The server 300 includes a predicting unit 310 and a planning unit 320. The predicting unit 310 executes processing for predicting a future charging/discharging amount by the V2X charging/discharging. Specifically, the predicting unit 310 acquires weather data and the like of the area of the consumer facility 200 from an external server (not illustrated). The weather data is weather forecast information of the region, and includes forecast information such as weather, temperature, and amount of solar radiation for each time period. In addition, the predicting unit 310 acquires the record information of the V2X charging/discharging from the electrically powered vehicle 100 and the consumer facility 200 at the time of executing the V2X charging/discharging. The record information includes, for example, a time during which the V2X charging/discharging is performed, information of power charged/discharged by the V2X charging/discharging, SOC information of the battery 110, and the like.

Then, the predicting unit 310 predicts a future charging/discharging amount by the V2X charging/discharging from the acquired weather data and the record information of the V2X charging/discharging. Various logics can be applied to the prediction logic of the V2X charging/discharging. For example, the predicting unit 310 predicts a time period in which the electrically powered vehicle 100 can be connected to the charging/discharging station 230 from the record information of the V2X charging/discharging. Then, the predicting unit 310 predicts the amount of charge by the V2X charge when the predicted time period is a time period in which the amount of solar radiation is predicted to be large, a midnight time period in which the electric power fee is inexpensive, or the like, and predicts the amount of discharge by the V2X discharging when the predicted time period is a peak time period of the electric power system 500, a time period in which the load of the electrical device 210 is high, or the like.

The planning unit 320 formulates a plan of V2X charging/discharging by the electrically powered vehicle 100. Specifically, the planning unit 320 acquires, from an external server (not shown), electric power trading price data in the power trading market and information on the DR when participating in the DR. In addition, the planning unit 320 acquires, from the user terminal 400, various settings of the V2X charging/discharging by the user (the owner of the electrically powered vehicle 100, the administrator of the consumer facility 200, or the like).

The user can instruct various settings related to V2X charging/discharging from the user terminal 400. Specifically, the user can set the target SOC of the battery 110 at the end of the V2X charging/discharging, the SOC upper limit value and the SOC lower limit value of the battery 110, the departure time of the electrically powered vehicle 100 after the V2X charging/discharging, and the like from the user terminal 400. Each setting value input in the user terminal 400 is transmitted from the user terminal 400 to the server 300.

Then, the planning unit 320 formulates a V2X charging/discharging plan using the charging/discharging amount of the V2X charging/discharging predicted by the predicting unit 310, each setting value from the user terminal 400, the electric power trading price data and the DR information acquired from the external server, and the like. Various logics can be applied to the charging/discharging plan formulation logic, and for example, a V2X charging/discharging plan capable of realizing the predicted charging/discharging amount as much as possible while responding to the DR request is formulated from the viewpoint of economic optimum (cost optimum) using each setting value (departure time, target SOC, SOC upper limit value, SOC lower limit value, and the like) from the user terminal 400 as a constraint condition.

As described above, the electrically powered vehicle 100 can convert kinetic energy of the vehicle into regenerative electric power and store the regenerative electric power in the battery 110 during braking. However, when traveling is started after the V2X charge, and when the temperature of the battery 110 is low in a state where the SOC is high because of the V2X charge, the charge of the battery 110 is largely limited. As a result, the regenerative electric power (regenerative power generation) at the time of braking is limited, and effective utilization of the regenerative energy is inhibited.

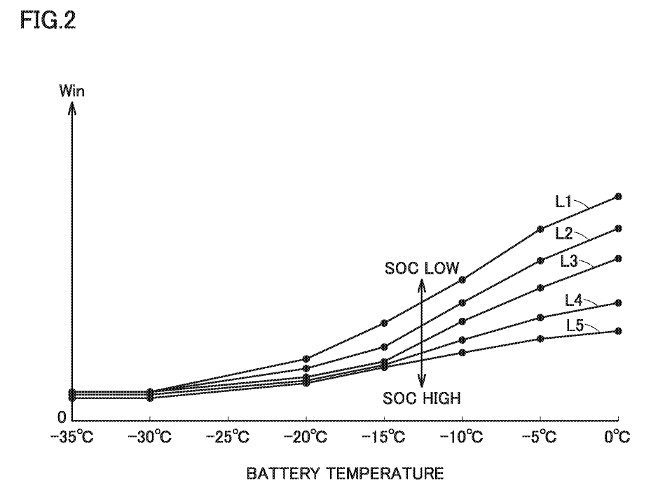

FIG. 2 is a diagram illustrating charging characteristics of the battery 110. In FIG. 2, the horizontal axis indicates the temperature of the battery 110, and the vertical axis indicates the charging limit Win (kW) indicating the upper limit of the charging power of the battery 110. The charging limit Win is provided from the viewpoint of battery protection, and the current of the battery 110 is controlled so that the charging power of the battery 110 does not exceed the charging limit Win.

Referring to FIG. 2, lines L1 to L5 indicate temperature characteristics of charge limit Win when the SOC of battery 110 is different, and the SOC is sequentially higher from line L1 toward line L5. Regardless of the SOC, the lower the temperature, the smaller the charge limit Win. As for the SOC, the higher the SOC is, the smaller the charge limit Win becomes. Therefore, when the SOC is high at a low temperature, the charge limit Win is largely limited.

That is, when the SOC of the battery 110 is high under low temperature (particularly, extremely low temperature), the charge limit Win is largely limited. When the charging limit Win is largely limited, effective utilization of the regenerative energy is inhibited as described above. Such a situation may occur when V2X charging ends at low temperatures.

Therefore, in the present embodiment, when the plan of the V2X charging/discharging is formulated, the temperature of the battery 110 after the completion of the V2X charging/discharging is predicted, and the SOC upper limit value of the battery 110 is lowered when the predicted temperature falls below a threshold value at which the charge limit Win is largely limited (for example, several kW or less). In the present embodiment, as described above, the SOC upper limit value is set by the user from the user terminal 400, but the SOC upper limit value set by the user is lowered. For example, using the relationship shown in FIG. 2, the SOC upper limit value is lowered to the SOC where the charge limit Win exceeds 10 kW.

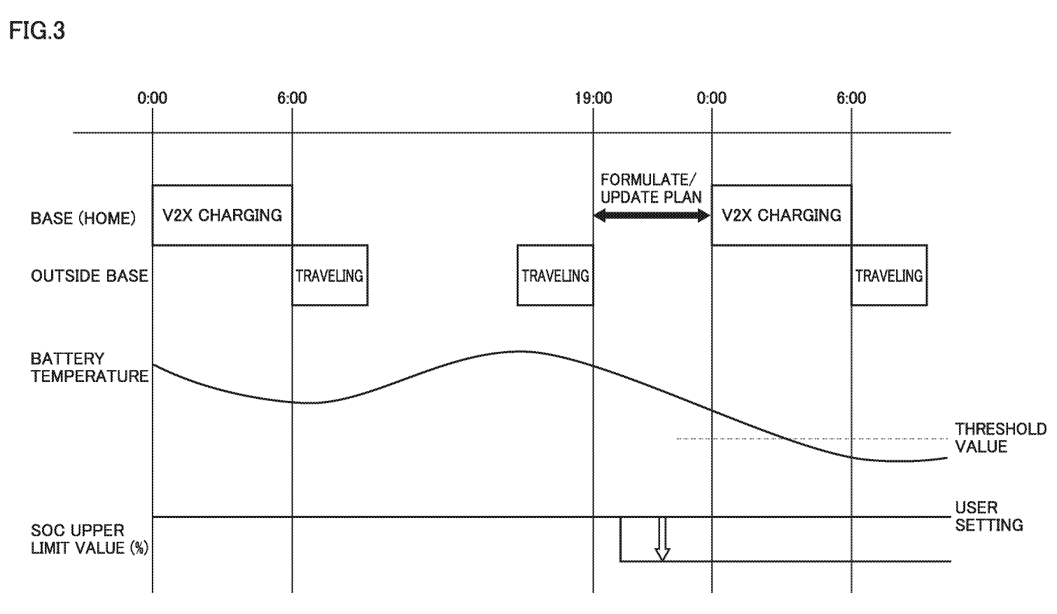

FIG. 3 is a timing chart when the SOC upper limit value is changed. Referring to FIG. 3, in this example, electrically powered vehicle 100 is used for commuting from around 6 o'clock on weekdays, and electrically powered vehicle 100 is also used when returning home at around 19 o'clock. Then, every night, the V2X charging/discharging is performed from about 0 o'clock to the travel start time (about 6 o'clock) of the next day. In this time period, the power price is low because of the midnight, and the load of the electrical device 210 of the consumer facility 200 is also low, so that the plan of the V2X charging in which the battery 110 is charged is formulated. Hereinafter, formulation of a V2X charging plan performed in this time period will be described.

The plan for V2X charging is formulated before V2X charging is initiated. As described above, the planning unit 320 of the server 300 formulates the V2X charging plan based on the charging/discharging amount predicted by the predicting unit 310, the setting values (the SOC upper limit value, the departure time, and the like) from the user terminal 400, the electric power trading price data, and the DR information.

The planning unit 320 plans the execution period of the V2X charging based on the departure time of the electrically powered vehicle 100 after the completion of the V2X charging, which is set from the user terminal 400 (in this example, 0 o'clock to 6 o'clock). Here, in this embodiment, the temperature of the battery 110 after the V2X charging is ended is predicted, and when the predicted temperature is lower than the threshold value, the SOC upper limit value set by the user from the user terminal 400 is lowered. The threshold value is a temperature at which the charging limit Win of the battery 110 is largely limited, and is set to an appropriate value (for example, 15°C). Alternatively, from the relationship shown in FIG. 2, the threshold value may be set to a temperature at which the charging limit Win is lower than the allowable lower limit (for example, several kW) in the SOC (target SOC) at the time of ending the V2X charging. The SOC upper limit value may be lowered by a predetermined amount (for example, 10 to 15%) from the SOC upper limit value set by the user, or the SOC upper limit value may be lowered to the SOC at which the minimum charge limit Win (for example, 10 kW) is obtained at the above-described predicted temperature.

Then, the planning unit 320 re-formulates (updates) the V2X charging plan using the lowered SOC upper limit value as a constraint condition. Then, the V2X charging is executed according to the updated plan. As a result, since the SOC is suppressed to be low under a low temperature after the V2X charging is ended, the limitation of the regenerative electric power (regenerative power generation) at the time of vehicle braking is relaxed in traveling after the V2X charging. Therefore, it is possible to effectively utilize the regenerative energy.

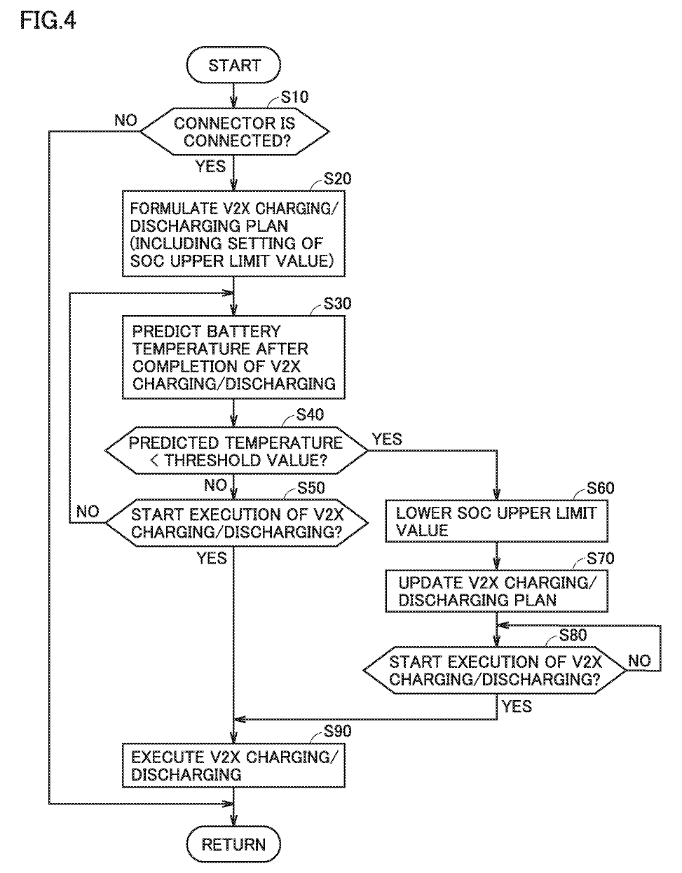

FIG. 4 is a flowchart illustrating processing performed by the server 300 regarding V2X charging/discharging. The series of processing shown in this flowchart is repeatedly executed every predetermined cycle or every time a predetermined condition is satisfied.

Referring to FIG. 4, server 300 determines whether or not the connector of the power cable extending from charging/discharging station 230 of consumer facility 200 is connected to the inlet of charging/discharging device 130 of electrically powered vehicle 100 (step S10). The connection of the connector is detected in the electrically powered vehicle 100 and/or the consumer facility 200, and the server 300 determines the connection of the connector by acquiring the detection result from the electrically powered vehicle 100 and/or the consumer facility 200.

When the connector is not connected to the inlet (NO in step S10), the server 300 proceeds to the return without executing the subsequent series of processes.

When the connector is connected to the inlet (YES in step S10), server 300 formulates a V2X charging/discharging plan (step S20). This process includes setting of the SOC upper limit value, the departure time of the electrically powered vehicle 100, and the like from the user terminal 400. Generally speaking, the server 300 predicts the V2X charging/discharging amount from the record of the V2X charging/discharging, the weather data, and the like, acquires each setting value (the SOC upper limit value, the departure time, and the like) from the user terminal 400, and formulates the V2X charging/discharging plan on the basis of the electric power trading price data and the DR information by using these settings as constraint conditions. For example, the V2X charging/discharging plan is formulated so that the SOC of the battery 110 does not exceed the SOC upper limit value and the V2X charging/discharging ends immediately before the departure time of the electrically powered vehicle 100.

Next, the server 300 predicts the temperature of the battery 110 after the completion of the V2X charging/discharging (step S30). The temperature of the battery 110 is appropriately predicted from, for example, the current temperature of the battery 110 and weather data (temperature prediction). The current temperature of the battery 110 is acquired from the electrically powered vehicle 100.

Next, the server 300 determines whether or not the predicted temperature of the battery 110 is lower than a threshold value (step S40). The threshold value is a temperature at which the charging limit Win of the battery 110 is significantly limited, for example, 15°C, but is not limited thereto.

When the predicted temperature of battery 110 is equal to or higher than the threshold value (NO in step S40), server 300 determines whether or not to start execution of V2X charging/discharging according to the plan formulated in step S20 (step S50). The execution start timing of the V2X charging/discharging is determined in the plan formulation of step S20 based on the departure time of the electrically powered vehicle 100 set from the user terminal 400.

When the execution start time of the V2X charging/discharging has not arrived (NO in step S50), the process returns to step S30. Then, when the execution start time of the V2X charging/discharging arrives (YES in step S50), the V2X charging/discharging is executed according to the plan formulated in step S20 (step S90).

In step S40, when it is predicted that the temperature of battery 110 after the completion of the V2X charging/discharging becomes lower than the threshold value (YES in step S40), server 300 lowers the SOC upper limit value of battery 110 (step S60). The SOC upper limit value is set by the user terminal 400 (a predetermined default value when there is no user input), and the server 300 lowers the SOC upper limit value from the setting by the user terminal 400. The SOC upper limit value may be lowered by a predetermined amount (for example, 10 to 15%), or the SOC upper limit value may be lowered to an SOC in which the charge limit Win exceeds a threshold value (for example, 10 kW) at the predicted temperature based on the charge characteristics of the battery 110 shown in FIG. 2.

When the SOC upper limit value of the battery 110 is lowered, the server 300 updates the V2X charging/discharging plan (step S70). Specifically, the V2X charging/discharging plan is formulated again using the changed SOC upper limit value as a constraint condition. As a result, the SOC of the battery 110 after the V2X charging is suppressed to the SOC upper limit value lowered in step S60.

Thereafter, when the execution start time of the V2X charging/discharging arrives (YES in step S80), the process proceeds to step S90, and the V2X charging/discharging is executed in accordance with the plan updated in step S70.

As described above, according to this embodiment, since the SOC is suppressed to be low when the temperature of the battery 110 is low after the V2X charging, the limitation of the regenerative electric power at the time of braking of the vehicle is relaxed in traveling after the V2X charging. Therefore, the regenerative energy can be effectively utilized.

### [First Modification]

In the above embodiment, the temperature of the battery 110 after the V2X charging/discharging is predicted, and when the predicted temperature is lower than the threshold value, the SOC upper limit value is lowered, and the plan of the V2X charging/discharging is formulated (updated). In the first modification, when the charge limit Win of the battery 110 becomes smaller than the threshold value in response to the predicted temperature of the battery 110 being low, the SOC upper limit value is lowered, and the V2X charging/discharging plan is formulated (updated).

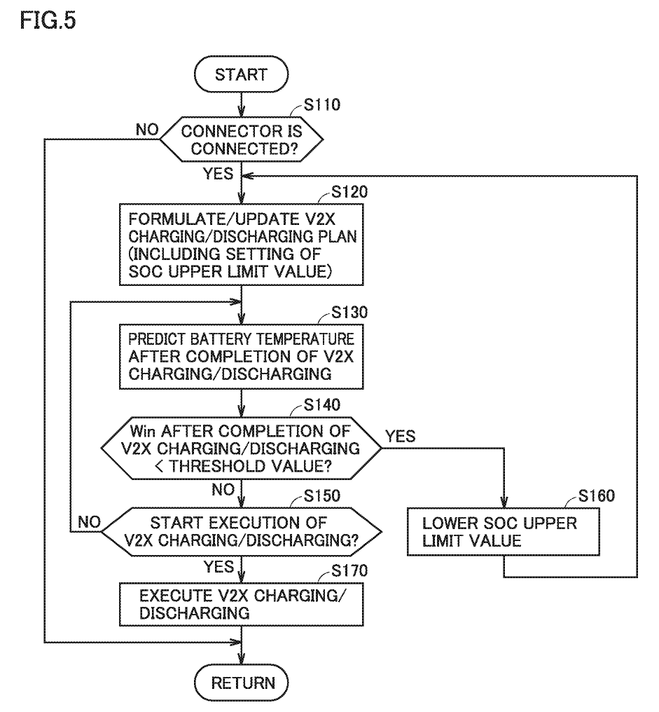

FIG. 5 is a flowchart illustrating processing executed by the server 300 according to the first modification. This flowchart corresponds to the flowchart shown in FIG. 4 in the above embodiment. The series of processing shown in this flowchart is also repeatedly executed every predetermined cycle or every time a predetermined condition is satisfied.

Referring to FIG. 5, the processes of steps S110 to S130 and S150 to S170 are the same as steps S10 to S30, S50, S60, and S90 of FIG. 4, respectively.

In the first modification, when the temperature of the battery 110 after the completion of the V2X charging/discharging is predicted in step S130, the server 300 predicts the charge limit Win of the battery 110 after the completion of the V2X charging/discharging based on the predicted temperature and the predicted SOC value of the battery 110 at the end of the V2X charging/discharging. The SOC prediction value is the target SOC by the V2X charging/discharging or the SOC upper limit value when the SOC upper limit value is lower than the target SOC. Then, the server 300 determines whether or not the predicted value of the charging limit Win is smaller than a threshold value (step S140). The threshold value is set to a value (for example, several kW) of the charge limit Win that greatly limits the regenerative power.

When charge limit Win after the completion of the V2X charging/discharging is equal to or greater than the threshold value (NO in step S140), server 300 proceeds to the process of step S150.

On the other hand, when it is predicted that charge limit Win after the completion of V2X charging/discharging becomes smaller than the threshold value (YES in step S140), the process proceeds to step S160, and the SOC upper limit value of battery 110 is lowered. Then, in the first modification, when the SOC upper limit value is lowered in step S160, the process returns to step S120, and the V2X charging/discharging plan is updated. Specifically, the V2X charging/discharging plan is formulated again using the changed SOC upper limit value as a constraint condition. As a result, the SOC of the battery 110 after the completion of the V2X charging is suppressed to the SOC upper limit value lowered in step S160.

As described above, in the first modification, after the V2X charging, when the temperature of the battery 110 is low and the charging limit Win is small, the SOC is suppressed to be low, and thus, in traveling after the V2X charging, the limit of the regenerative electric power at the time of braking of the vehicle is relaxed. Therefore, also according to the first modification, it is possible to effectively utilize the regenerative energy.

### [Second Modification]

In the above embodiment, as shown in FIG. 4, in step S30, the temperature of the battery 110 after the V2X charging/discharging is ended is predicted, but the temperature of the battery 110 at the predicted travel start time after the V2X charging/discharging may be predicted.

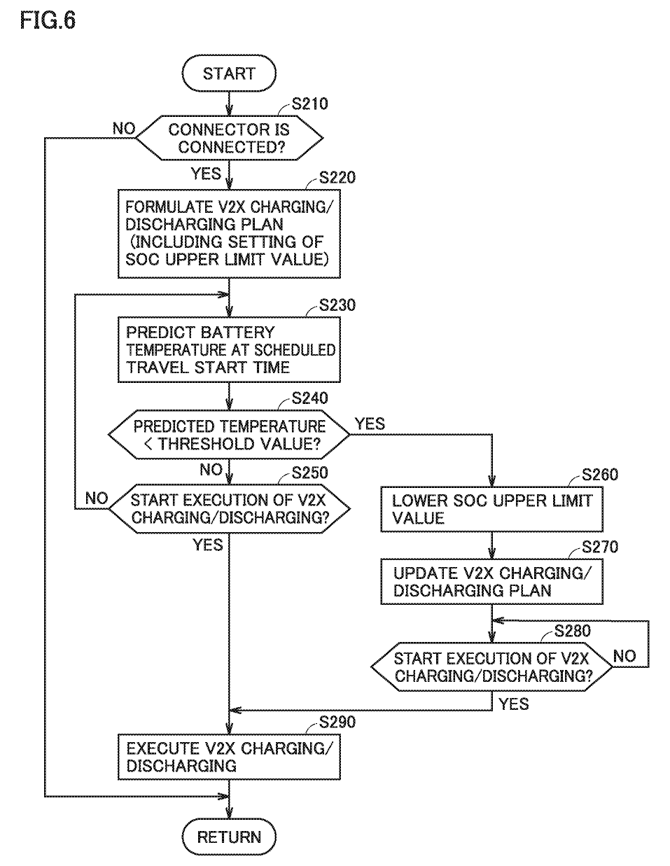

FIG. 6 is a flowchart illustrating processing executed by the server 300 according to the second modification. This flowchart corresponds to the flowchart shown in FIG. 4 in the above embodiment. The series of processing shown in this flowchart is also repeatedly executed every predetermined cycle or every time a predetermined condition is satisfied.

Referring to FIG. 6, steps S210, S220, and S240 to S290 are the same as steps S10, S20, and S40 to S90 of FIG. 4, respectively.

In the second modification, when the plan of the V2X charging/discharging is formulated in step S220, server 300 predicts the temperature of battery 110 at the scheduled travel start time of electrically powered vehicle 100 after the completion of the V2X charging/discharging (step S230). The scheduled travel start time of the electrically powered vehicle 100 is set as a departure time of the electrically powered vehicle 100 by the user terminal 400.

When the temperature of the battery 110 at the scheduled travel start time is predicted, the process proceeds to step S240, and it is determined whether or not the predicted temperature of the battery 110 at the scheduled travel start time is lower than a threshold value in step S230.

According to the second modification, similarly to the above-described embodiment and the first modification, the regenerative energy can be effectively utilized.

Although not particularly shown, the predicted temperature of the battery 110 after the completion of the V2X charging/discharging is used in the first modification, but the predicted temperature of the battery 110 at the predicted travel start time after the completion of the V2X charging/discharging may be used as in the second modification.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A charging control device for a vehicle,
the vehicle comprising:
a battery that stores electric power for traveling;
a driving device that generates a driving force for the vehicle using electric power stored in the battery, and generates regenerative electric power during braking of the vehicle to charge the battery; and
a charging device that charges the battery with a power supply external to the vehicle,
the charging control device comprising:
a processor; and
a memory that stores a program to be executed by the processor, wherein
in accordance with the program, the processor
makes a charging plan for charging the battery by the charging device such that an SOC of the battery does not exceed a set SOC upper limit value, and
predicts a temperature of the battery after being charged based on the charging plan, and
when the predicted temperature is low, the processor makes the charging plan by setting the SOC upper limit value lower than the SOC upper limit value when the predicted temperature is high.

2. The charging control device according to claim 1, wherein, when charging power for the battery is limited to a predetermined value or less due to a decrease in the temperature, the processor makes the charging plan by setting the SOC upper limit value to a lower value.

3. The charging control device according to claim 2, wherein, when the charging power is limited to the predetermined value or less due to a decrease in the temperature, the processor makes the charging plan by lowering the SOC upper limit value set by a user of the vehicle.

4. The charging control device according to claim 1, wherein
the processor
makes the charging plan such that charging of the battery has been completed at a set travel start time of the vehicle, and
predicts the temperature, at the travel start time, of the battery after being charged based on the charging plan.

5. A charging system used for charging a vehicle,
the charging system comprising:
a charging facility to which the vehicle is to be connected; and
a charging control device for the vehicle,
the vehicle comprising:
a battery that stores electric power for traveling;
a driving device that generates a driving force for the vehicle using electric power stored in the battery, and generates regenerative electric power during braking of the vehicle to charge the battery; and
a charging device that charges the battery with electric power supplied from the charging facility, wherein
the charging control device
makes a charging plan for charging the battery by the charging facility such that an SOC of the battery does not exceed a set SOC upper limit value, and
predicts a temperature of the battery after being charged based on the charging plan,
when the predicted temperature is low, the charging control device makes the charging plan by setting the SOC upper limit value lower than the SOC upper limit value when the predicted temperature is high, and
the charging facility charges the battery in accordance with the charging plan made by the charging control device.
